(19) United States
(12) Patent Application Publication
(10) Pub. No.: US 2013/0124009 A1
(43) Pub. Date: May 16, 2013

(54) METHOD AND SYSTEM FOR MANAGING PERSONAL SETTINGS ON A VEHICLE

(71) Applicant: Craig Edward Esler, Plymouth, MI (US)

(72) Inventor: Craig Edward Esler, Plymouth, MI (US)

(73) Assignee: FORD GLOBAL TECHNOLOGIES, LLC, DEARBORN, MI (US)

(21) Appl. No.: 13/295,115

(22) Filed: Nov. 14, 2011

(51) Int. Cl. G06F 17/00

(52) U.S. Cl. 701/2; 701/1

(57) ABSTRACT

The present disclosure provides a system and method for managing vehicle configurations. A database containing a plurality of configuration templates is provided. The configuration template contains parameters of configurable features and settings for its corresponding vehicle. A user is provided with a configuration application to obtain and personalize the configuration template of her vehicle. The personalized configuration data is transferred to a control module of the vehicle to adjust the features and settings in accordance with the user's configuration data.

### TECHNICAL FIELD

This disclosure relates generally to the field of motor vehicles. More specifically, the disclosure relates to a system and method for managing personal configurations of vehicles.

### BACKGROUND

Motor vehicles are evolving. New technologies are dramatically changing what consumers expect from motor vehicles. Rather than the vehicle's performance or fuel efficiency, features increasingly influence consumers' purchase decisions. With this continuing trend, more and more high-tech features are finding their way into motor vehicles. Many motor vehicles now have hundreds of features ranging from basic items such as seat adjustment and temperature control to more advanced matters such as automatic parallel parking and driver pattern recognition systems. In addition, motor vehicles no longer constitute mere transportation, but they have become a personal space, where one can share and socialize, as well as be informed and entertained, all while keeping one's eyes on the road. For example, the voice text messaging feature, found in control systems such as Ford's SYNC, enables the driver to safely send hands-free messages. These modern in-vehicle control systems even integrate popular online computer applications such as Pandora, Facebook, and Twitter.

This increase in the number of features of vehicle, however, exacts a cost. The more features the vehicle has and the more advanced the features become, the lengthier and more complex the configuration process becomes. Typically, a driver must refer to the owner's guide to understand the various parameters and attributes, and to learn how to configure them. This process requires considerable time, and it must be repeated whenever one acquires a new vehicle. In addition, different drivers prefer different settings, and any change requires a return to the owner's guide. The ever-increasing complexity of vehicle configuration presents a need for a system and method for managing personalized vehicle configurations in easy and efficient manner. Further, some owners have multiple vehicles, and others share a single vehicle. Accordingly, there remains a need for a system and method to easily store a configuration, transfer the stored configuration, and efficiently apply the configuration from vehicle to vehicle.

### SUMMARY

One embodiment of the present invention is a method for managing personal settings of a user in one or more vehicles. The method includes identifying a vehicle for configuration, obtaining a configuration data containing parameters that are associated with various settings of the identified vehicle, receiving adjustment values to update the parameters in the configuration data, and adjusting the settings of the vehicle in accordance with the configuration data when the configuration data is transferred to the vehicle. The vehicle is identified from one or more vehicle identification data obtained by the vehicle configuration application. The configuration application retrieves the configuration data of the identified vehicle, which contains one or more parameters/attributes associated with configurable settings of the identified vehicle. The configuration application obtains one or more adjustment values to update the configuration data. The updated configuration data is transferred to the control module of the vehicle, which configures the features and settings in accordance with the parameters of the configuration data. In one particular embodiment of the present invention, the configuration application pre-populates the parameters in the configuration template of the user's new vehicle by analyzing the user's vehicle related patterns such as driving patterns, vehicle configuration patterns, and/or features usage patterns. The user's pattern data can be obtained from, for example, the user's previously adjusted configuration data, the control module of the user's vehicle, and the user client. In one embodiment, the parameters in the configuration template is simply pre-populated with the values of same or similar category of parameter of the user's previously stored configuration data.

Another embodiment of the present invention relates to a system for managing personal settings of a user for one or more vehicles. The system comprises a user client for accessing and executing a sequence of instructions for identifying a vehicle for configuration, obtaining a configuration data corresponding to the identified vehicle, interacting with the user to personalize one or more parameters of the configuration data, and communicating with a control module of the identified vehicle. The user client further includes a processing module, a memory module, a communication interface, and an input/output module (“IO module”), all of which are generally found in typical computing devices such as computers, mobile phones, and the like. The system also includes a control module operatively coupled to various devices and modules of a vehicle to adjust settings and control functions of the vehicle in accordance with the received configuration data.

Another embodiment of the present invention relates to one or more non-transitory computer readable mediums (e.g., one or more compact disk, diskettes, servers, flash memories, hard drives, removable hard drives, or a cloud computing storage system) encoded with instructions for receiving one or more vehicle identification data, acquiring a configuration data corresponding to the vehicle identification data, presenting one or more parameters/attributes contained in the acquired configuration data, and transferring the adjusted configuration data to a control module of the identified vehicle. The non-transitory computer readable medium can further include computer executable instructions for analyzing the user's vehicle related patterns to automatically populate the parameters of configuration templates for the user.

Further embodiments, features, and advantages of the invention, as well as the structure and operation of the various embodiments of the present invention are described in detail below with reference to accompanying drawings.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a block diagram of an exemplary vehicle configuration management system for managing users' personal configurations for their vehicles, according to an embodiment of the present disclosure.

FIG. 2 is a flow chart of an exemplary method for managing users' personal configurations for their vehicles, according to an embodiment of the present disclosure.

FIG. 3A illustrates an exemplary graphical user interface for receiving information to identify a vehicle for configuration, according to an embodiment of the present disclosure.

FIG. 3B illustrates an exemplary graphical user interface for presenting parameters contained in a configuration data and receiving adjustment values from a user, according to an embodiment of the present disclosure.

FIG. 4 is a block diagram illustrating an exemplary vehicle database structure, according to an embodiment of the present disclosure.

### DETAILED DESCRIPTION

The following detailed description is made with reference to the figures. Exemplary embodiments are described to illustrate the subject matter of the disclosure, not to limit its scope, which is defined by the appended claims.

In the following description, the term “configuration data” refers broadly and inclusively to any configuration data containing a set of parameters and attributes associated with a vehicle's settings and features. The term “configuration template,” however, refers to a specific type of configuration data, which contains parameters with default values that have not been altered by the user. Although, the terms “configuration data” and “configuration template” are used distinctively for the purposes of explanation in many parts of the present disclosure, one of skill in the art will recognize that the configuration template and the configuration data can be interchangeably used in some embodiments described herein as appropriate. The term “control module” includes not only a single control module but also individual modules on a vehicle network.

Today, a vehicle is more than just a machine that takes a person one point to another. The vehicle has been transformed into a personal space that functions as a mobile communication station, an information hub, and an entertainment center, making a driver's time on the road more informative and enjoyable. Vehicles have hundreds of settings that can be personalized to enhance one's driving experience. With an ever-growing number of adjustable settings in the vehicle, the driver is often required to spend considerable time going through the owner's guide to learn and configure available settings.

Accordingly, a configuration application and configuration templates are employed to provide an efficient vehicle configuration process. The configuration application acquires information specifying the user's vehicle as well as the configuration template for the specified vehicle. The configuration template is tailored to the vehicle, and it only contains parameters of configurable features and settings in the vehicle to minimize time being wasted for learning and trying to configure unavailable or non-configurable settings. The efficacy of the present disclosure is increased by analyzing the user's vehicle related patterns such as driving patterns, configuration patterns, and features usage patterns, to pre-populate the configuration templates for the user. With the present disclosure, a user can easily identify available features, learn about them, personalize settings, and apply the settings. In addition, the user can generate multiple versions of personalized settings, which can be easily applied to the vehicle via any commonly known human-computer interaction mechanisms, such as a voice command or a touch screen input. Further, the user's personalized settings on one vehicle can be applied to other vehicles, providing a quick and easy way of configuring the user's new vehicle.

### System Overview

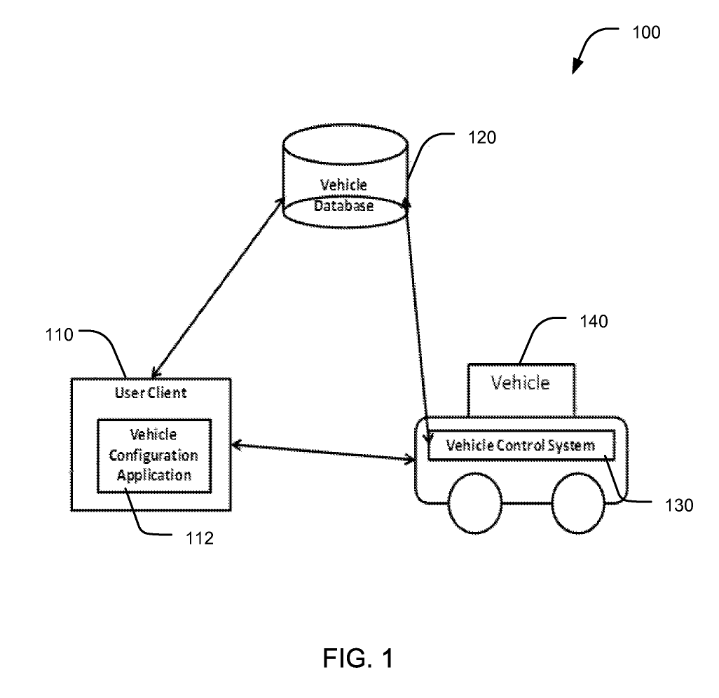

One environment in which embodiments of the present disclosure may operate includes one or more user clients, one or more databases, and a control module operatively coupled to a vehicle. FIG. 1 is an exemplary vehicle configuration management system 100, including a user client 110, a vehicle database 120, and a control module 130 operatively coupled to a vehicle 140. The user client 110 may include a configuration application 112 configured to interact with a user to obtain various user inputs such as vehicle identification data and adjustment values. The configuration application 112 also manages the overall communications between the components (e.g., vehicle database 120, control module 130) of the system 100 to provide configuration data containing the user's preferences for the available settings and features in vehicle 140. It also contains information for identifying the user's specific vehicle or at least the model identification. The vehicle database 120 also contains one or more configuration templates for vehicles that are compatible with the vehicle configuration management system 100. The user adjusts the parameters/attributes of the configuration data according to her preferences, and the personalized configuration data is stored in one or more storage locations. The configuration application 112 may store the user adjusted configuration data in the user client 110, and optionally store remotely by transferring the configuration data to a remote server. Also, the configuration data can be stored in a removable storage device, such as a USB flash drive or any other non-volatile storage medium.

The control module 130 communicates with the configuration application 112, or with vehicle database 120, or both, to obtain the user's personalized configuration data for the vehicle 140. The control module 130 is operatively coupled to various devices and modules to configure vehicle 140 according to that data. Communications among these components may be achieved via various types of network links (physical, optical, wireless, or otherwise) on a personal area network, a local area network, a wide area network, or a combination of such networks, employing appropriate data transfer protocols.

The user client 110 may include a number of devices, such as a computer, a mobile phone, or similar devices, or a network made up of such devices. It is sufficient that the user client 110 enables the user to interact with the configuration application 112, and enables the configuration application 112 to communicate with the vehicle database 120 and with the control module 130, as appropriate. Likewise, the vehicle control module 130 may be any number of devices including a computer, an embedded system, or a standalone electronic device, or any combination of similar systems and devices. It is sufficient that the control module 130 is capable to obtain a configuration data and adjust settings of the vehicle, as appropriate. The configuration application 112 can be implemented in appropriate software (e.g., C, C++, Java, or other suitable programming language) in hardware (such as used in gate level logic or ASIC), or firmware (e.g., microcontroller configured with I/O capability for receiving data from external sources and a number of routines for generating and transferring of a configuration data as described herein), or some combination thereof.

### Configuration Application

In some embodiments, the configuration application 112 is implemented as a software application, installed on the user client 110. In some other embodiments, however, the configuration application 112 is installed on a remote system, separated from the user client 110. For instance, the configuration application 112 can be implemented as a server-side application accessible via the network, using intermediate applications such as web browsers (e.g., Microsoft Internet Explorer, Mozilla Firefox, or Apple Safari) on the user client 110. Such an implementation, when coupled with other necessary components of the system, can provide an independent vehicle configuration management system 100. There, the user is not tied to a single designated user client. That is, the configuration application 112 can be accessed from the user's home computer, the user's laptop in the office, or the user's mobile phone. Any compatible device can be used to adjust or re-adjust the user's configuration data. In this embodiment, however, accessing the configuration application 112 may require a suitable network connection to the server hosting the configuration application 112.

### Vehicle Database

The vehicle database 120 contains information for identifying the user's specific vehicle or a vehicle model, as well as configuration data templates of vehicles compatible with the system 100. A configuration template is a standardized set of configuration data, which contains various parameters associated with adjustable features according to vehicle model. Parameters of the configuration data may be associated with, settings affecting climate control settings, seat position settings, or similar user preferences. It would be desirable if each configuration template in the vehicle database 120 were pre-formatted for a particular vehicle model, specifically tailored to contain only the parameters affecting that vehicle.

The vehicle identification data can identify a specific vehicle, or at least a specific vehicle model, that the user wishes to configure. That data may include a vehicle identification number (“VIN”), Year/Make/Model information, user account information, and a unique user client identifier (e.g., MAC address, user's phone number). In some embodiments, the user creates a user account and provides information regarding the vehicles she owns, drivers of the vehicles, or any other ancillary information such as third party subscription services membership information such as Facebook login, default preferences on vehicle settings, as appropriate. In some other embodiments, the configuration application 112 obtains unique identifier associated with the user client 110, and it uses this information in conjunction with the other information provided by the user to identify the vehicle to be configured.

In some embodiments, the vehicle database 120 stores extra information, such as user account data or previously stored configuration data. The user account data can contain a variety of information in full or indexed form. Information in a user account data may include, for example, a user ID, a list of vehicles that the user owned or currently owns unique vehicle identifiers and/or unique user client identifiers associated with a user ID, and previously stored configuration data associated with the user ID, and the like. Although the vehicle database 120 is implemented as a single database unit in FIG. 1, it should be understood that in some embodiments, each of the information/data described above can be stored in several discrete databases implemented in multiple servers so as to improve reliability or other factors. In one embodiment, the vehicle database 120 is implemented in the user client 110, where it may be integrated with the configuration application 112.

The vehicle database 120 identifies the vehicle from a query or search request received from the configuration application 112, and the vehicle database 120 returns a corresponding configuration template or the user's previously stored configuration data. In that setting, the configuration application 112 has access to the information stored in the vehicle database 120 even in the absence of a network connection. Here, identification of a vehicle, acquisition of a configuration template or a previously adjusted configuration data, calibration of the configuration template/data, and transmission of the personalized configuration data to the control module 130, can be done with a single computing device. In that setting, assuming the user client 110 can communicate with the control module 130 managing the user's vehicle configuration is possible even when the user client 110 is disconnected from a wide area network such as the Internet.

In another embodiment, the vehicle database 120 is implemented in a remote server, and the configuration application 112 communicates with the vehicle database 120 via the network. Many advantages can be realized in such setting as well. First, the vehicle database implemented in a remote server can provides a reliable backup location for the user's configuration data. The user does not have to worry about losing personalized configuration data even when his user client (e.g., computer, mobile phone) is lost or becomes inoperable. Second, such implementation saves valuable storage space in the user client 110. The user needs to download only the necessary configuration data from the vehicle database 120. This is especially advantageous when the user client 110 is a portable device without a non-volatile storage or has a very limited storage capacity. Also, the process of updating the information in the database becomes easy and efficient because only the database in the remote server needs to be updated. Furthermore, the remote server implemented vehicle database enables a device (e.g., user client) independent vehicle configuration management system. The user can access the configuration template as well as his previously stored configuration data, from anywhere, using any compatible user client. For example, a user can start the configuration process of his vehicle on his office computer, and the user can save the configuration data in the middle of the process. The user can obtain the saved configuration data from the vehicle database in the server, and continue the configuration process in his vehicle using his mobile phone. After the user arrives home, the user can re-calibrate the configuration data using his home computer.

Accordingly, it would be desirable to implement the vehicle database 120 both locally in the user client 110 as well as remotely on a server. The locally implemented vehicle database needs not be as elaborated as the remotely implemented vehicle database 120 in the server. The vehicle database in the user client 110 can be implemented to store only some of the data that are frequently accessed by the users, such as configuration template of popular vehicle models, each user's previously adjusted configuration data, and automatically generated configuration data based on the user's (or a general population of users) configuration preferences. Also, the information stored in both the local vehicle database and the remote vehicle database can be configured to synchronize with each other, forming a cloud database system, to provide the benefits of both embodiments discussed above.

Although the configuration application 112 and the vehicle database 120 are illustrated as being implemented as discrete components of the vehicle configuration management system 100, they can be implemented in a single component in other embodiments of the present disclosure. In one embodiment, both the configuration application 112 and the vehicle database 120 are implemented in the user client 110. Alternatively, the configuration application 112 and the vehicle database 120 are implemented in a remote server.

### Control Module

The control module 130 is connected with other modules and devices for adjusting and controlling the features of the vehicle 140. When the control module 130 receives configuration data, it communicates with other modules and devices of the vehicle 140 to configure them in accordance with the parameters in the configuration data. In an embodiment, the control module 130 obtains the configuration data from the user client 110, a wired or wireless connection, including, respectively, a serial bus, configured as a USB, FireWire, or similar device, or optical, magnetic, or similar connections.

Many vehicles are now being equipped with some form interface to handle Internet communications. Accordingly, in an alternative embodiment, the control module 130 obtains configuration data from the vehicle database 120 implemented in a remote server. The control module 130 may communicate with the remote server on its own, or it may utilize this Internet communication function, on its own or through devices such as the user client.

In yet another embodiment, the control module 130 is provided with a physical receptacle to attach portable storage devices, such as a USB flash drive, SD card, or the like. This setting is particularly useful when the user client 110 is not portable). For instance, the user can prepare a configuration data using a desktop computer and save the adjusted configuration data onto a USB flash drive. The user inserts the USB flash drive to the provided receptacle to transfer the adjusted configuration data to the control module 130.

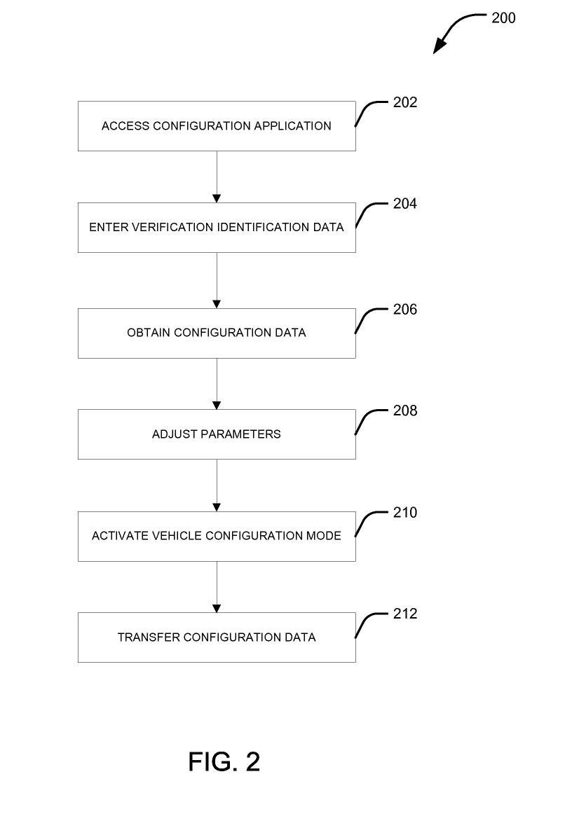

A process carried out by the vehicle configuration management system 100 according to some embodiments of the disclosure can be understood with reference to FIG. 2. FIG. 2 is a flow diagram illustrating the method for managing vehicle configuration in one embodiment of the present disclosure.

As shown in FIG. 2, the user accesses the configuration application 112 via the user client 110 (step 202). In a preferred embodiment, the user client 110 is a portable computing device, such as a mobile phone, and the configuration application 112 us implemented in the user client 110 or can be downloaded via a network. The user client 110 can communicate with the control module 130 via a wired, a wireless connection, or any combination thereof. Today, a mobile phone or other portable computing devices come with a considerable size of storage capacity. Not only can the user client 110 store the configuration application 112 in its local storage, but the user client 110 can store the entire vehicle database 120 or at least some part of the vehicle database 120 inside its local storage. In such embodiments, identifying the vehicle, obtaining and adjusting the configuration data of the identified vehicle, as well as transferring the configuration data to the control module 130 can be accomplished using a single device.

Even when the vehicle database 120 is a limited one that does not contain configuration templates for every compatible vehicle, the user client 110 can communicate with the control module 130 to obtain necessary information as well as other ancillary information. As mentioned above, the user client 110 and the control module 130 can be paired (or synced) via a wire or wireless connection, establishing a bi-directional data communication between the two. The control module 130 can provide information as to the vehicle's available features and settings, which the configuration application 112 can use to create the configuration template. In addition, the control module 130 can provide the vehicle's current parameter/attribute values of those features and settings. Other ancillary information the control module may provide include, for example, the user's driving pattern including the usual driving speed, number of lane changes, etc., the user's configuration pattern, such as climate control settings and the like, and the user's pattern in using features, such as air conditioning usage data). Such information can be utilized by the configuration application 112 to generate a configuration data, not only specific to the vehicle but also tailored to the user unique habits and patterns.

The user interacts with the configuration application 112 via a graphical user interface (“GUI”) to identify or select the vehicle 140 for configuration. (step 204) The user can select or identify the vehicle by simply choosing one of her previously stored configuration data or by entering one or more vehicle identification data. In an embodiment, the user enters a unique vehicle identifier, such as the VIN, or Year/Make/Model information. In yet another embodiment, the user enters his membership registration information, such as a user ID and password associated with the user's account. The user account scheme can be useful when the user has multiple vehicles or when a single vehicle is shared among many different users. Sometimes, a user may want to apply different vehicle settings for different occasions. For example, the user might want to have one set of radio stations during the day time and another set of radio stations during the night time. Accordingly, the user may generate multiple versions of the configuration data, each having different parameter values for the same vehicle. Similarly, the user may have additional sets of configuration data for her other vehicles. Also, a single vehicle may be shared among the family members, each having different configuration data. The aforementioned scenarios result in one vehicle being associated with multiple configuration data. As such, properly indexing a plurality of configuration data with a plurality of vehicles in the vehicle database 120 can become a complex task. The complexity increases significantly if the vehicles are equipped with some features that consider ranks (e.g., hierarchy) among the drivers/users. For example, many vehicles are now being equipped with parental control features that permit parents to configure the vehicle's maximum speed, behavior of seatbelt warning system, and even the maximum audio volume. To enforce such parental control features, the vehicle configuration management system 100 must recognize which configuration data takes priority over other configuration data. Accordingly, the user account can be useful in organizing the relationships between a plurality of configuration data of users and the vehicles. Furthermore, the user account can be used to keep track of individual user's previous vehicles, previous configuration data, and even the user's patterns (e.g., driving, configuration, features usage patterns), which can be recognized or otherwise gathered from the user's vehicle or a collection of previous configuration data.

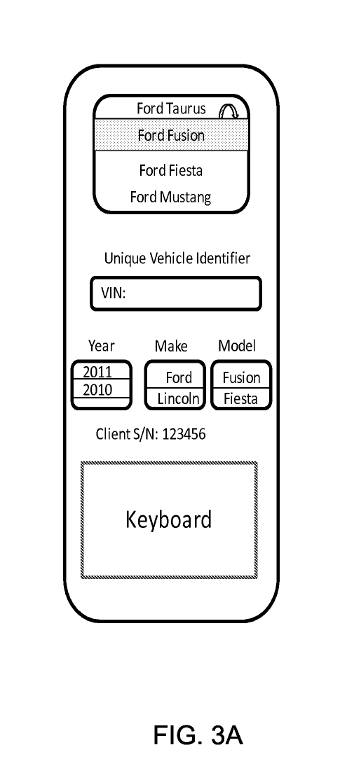

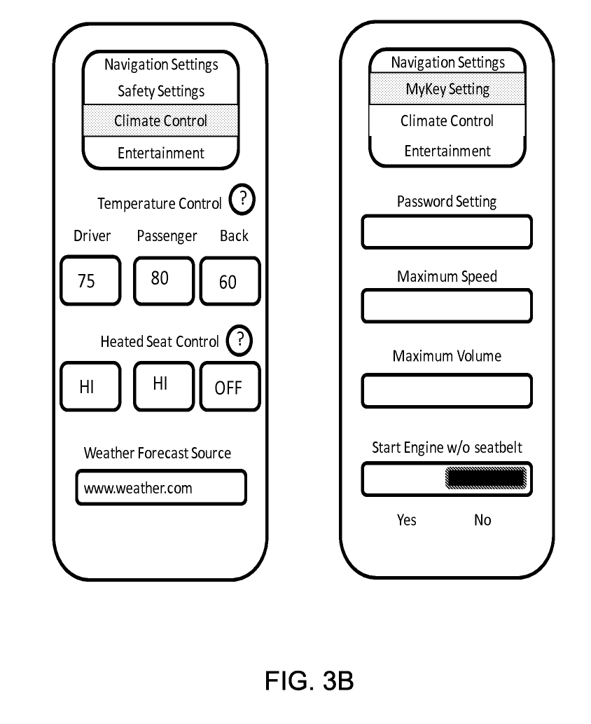

FIG. 3A is an exemplary illustration of the GUI for entering the vehicle identification data to identify a vehicle. As shown in FIG. 3A, the top portion of the GUI provides a list of vehicles that the user previously configured via the configuration application 112. This list can be populated from the previously adjusted configuration data stored in the user client 110 or the vehicle database 120. Here, the user can recalibrate the corresponding configuration data, simply by selecting a vehicle from the list via man-machine interface, such as voice command or touch screen provided in the user client. A similar user interface can be provided for the user to select and transfer an adjusted configuration data to the control module 130. As shown in FIG. 3A, the GUI also provides a text field for entering a VIN as well as an interface for selecting Year, Make, and Model of the vehicle. As mentioned earlier, each user client 110 may have its own unique identifier, such as a MAC address or a serial number, and such information can be displayed in the GUI, as depicted in FIG. 3A.

Upon receiving the vehicle identification data, the configuration application 112 may generate one or more queries and communicate with the vehicle database 120 to identify the vehicle matching the query. The vehicle database 120 contains information regarding the vehicles that are compatible or otherwise configurable with the various embodiments of vehicle configuration management system 100 of the present disclosure. Each specific vehicle or vehicle model in the vehicle database 120 may be assigned with a unique vehicle identifier or otherwise indexed in commonly known data index architectures scheme.

When a specific vehicle or a vehicle model is identified, the vehicle database 120 returns configuration data corresponding to the specific vehicle or the configuration template of the identified vehicle model. (step 206) As previously noted, each configuration template is tailored to a particular vehicle model to contain only the parameters/attributes of configurable settings of the vehicle. The features and settings which can be associated with the parameters/attributes of the configuration data are virtually limitless. Accordingly, the techniques and concepts described herein can be applied to manage any adjustable or modifiable features, settings, and configurations of vehicles, devices integrated or connected to the vehicle, as well as software for controlling the devices and the vehicles. Although using a tailored configuration template is preferred, in some embodiments of the present disclosure, a generic configuration template can be used when necessary. The generic configuration template may contain parameters/attributes for vehicle features and settings generally known in the industry, and such template can be used when the user client 110 cannot obtain the tailored configuration template.

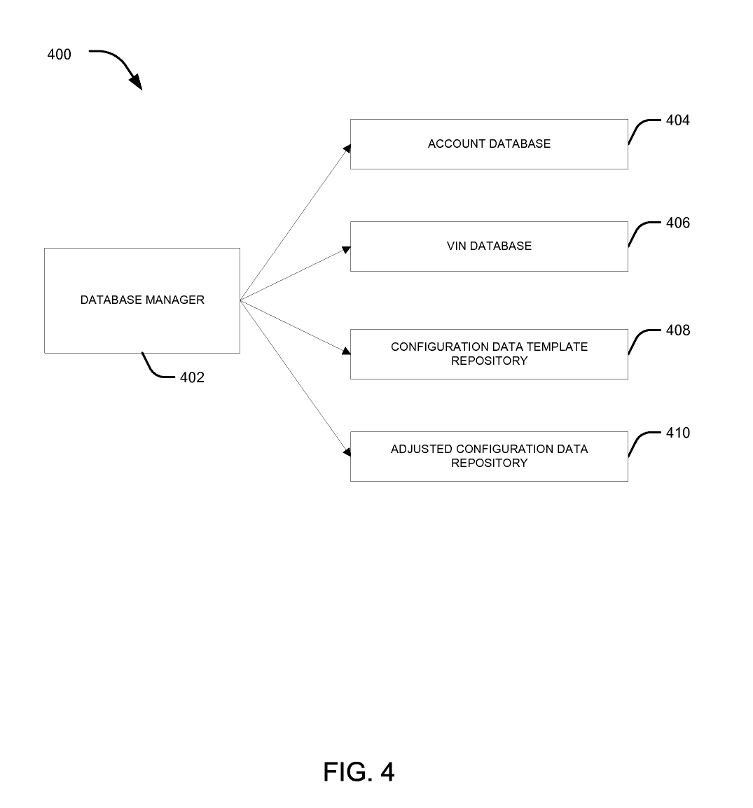

FIG. 4 illustrates an exemplary database structure 400 according to an embodiment of the present disclosure. The database manger 402 handles a set of routines for indexing, identifying, storing, and retrieving information from other networked databases (e.g., a user account database 404, a VIN database 406, a configuration template repository 408, and a configuration data repository 410). The database manager 402 may also manages overall communication between the user client 110 of FIG. 1 and other networked databases depicted in FIG. 4.

As mentioned earlier, the user account database 404 may contain a plurality of user account IDs and information about the vehicles associated with each user account. The information in the user account database 404 may include, for example, indexes of a plurality of user accounts referencing users, vehicles associated with the users, VIN of those vehicles, and the physical storage location of previously adjusted configuration data for the vehicles. The VIN database 406 may include a list of vehicles and the unique vehicle identifiers for each corresponding vehicles of the list. The configuration template repository 408 may store one or more configuration templates for vehicles. The configuration template contains the parameters/attributes associated with the adjustable settings of a particular vehicle, and the parameters/attributes are pre-populated with default values. The configuration data repository 410 may store one or more configuration data that are adjusted and saved by the users. Although each of the databases are discretely illustrated in FIG. 4, the functionality of the database manager 402, the user account database 404, the VIN database 406, the configuration template repository 408, and the adjusted configuration data repository 410, or any combinations thereof, may be combined into one component in some other embodiments of the present disclosure.

In one embodiment, the user provides a unique vehicle identifier such as VIN. Because each vehicle has distinct VIN, the database manager 402 can pin-point the information pertaining to the user's specific vehicle. Using the vehicle's unique vehicle identifier is particularly advantageous when retrieving the user's previously stored configuration data from the configuration data repository 410 implemented in a remote server. The database manager 402 can be configured to communicate with the configuration data repository 410 to search for any configuration data with the matching VIN. Even when the database manager 402 fails to locate a matching configuration data, it can identify the model of the vehicle from the VIN, which can be used to obtain a corresponding configuration template from the configuration template repository 408.

In other embodiment, the user provides Year/Make/Model information of the vehicle. Although this information can identify a vehicle model, it cannot pin-point the user's specific vehicle as the unique vehicle identifier. As such, the database manager 402 would normally return a configuration template for the identified vehicle model. Nonetheless, these types of broad vehicle identification data can be used in conjunction with unique identifiers associated with the user to identify the user's specific vehicle. For example, the each user client 110 may be assigned with its own unique identifier, such as a media access control (“MAC”) address or a serial number. In embodiments where the user client 110 is a mobile phone, the phone number can function as a unique identifier. The configuration application 112 can be configured to extract or otherwise obtain the unique identifier of the user client 110. The configuration application 112 can generate a query for searching any configuration data associated with the unique user client identifier that corresponds to the identified vehicle model.

As discussed above, another embodiment of the present disclosure uses user account architecture. In this setting, each user creates a user account which can be used to link all the relevant information of the user, such as vehicles of the user, previously stored configuration data of the vehicles, and various other information and data which may be used in the embodiments of the present disclosure described in this disclosure.

When the configuration application 112 receives, either a configuration template or a previously stored configuration data, the configuration application 112 displays or otherwise presents the parameters/attributes contained in the obtained data. The configuration template or the configuration data is specifically tailored for the configuring vehicle, so that the users don't waste their time and effort in learning and providing adjustment values on unavailable or non-configurable features. The efficacy of the vehicle configuration management system is further increased when the configuration template for a user's new vehicle is pre-populated with the parameters/attributes values from the user's previously stored configuration data. While the features and settings available in the new vehicle may not be identical to the user's other vehicles, both vehicles may share a number of common features. Accordingly, in an embodiment, the configuration application 112 pre-populates the parameters/attributes in the configuration template with the user's previously adjusted configuration data. For example, parameters/attributes the climate control setting in the configuration template can be pre-populated with the parameters/attributes values from the user's previously adjusted configuration data, which can be of a different vehicle model.

Referring back to FIG. 2, the user interacts with the configuration application 112 to enter parameter values and enable/disable features presented in the configuration template/data. (step 208) FIG. 3B is an exemplary illustration of the GUI for displaying the parameters and attributes contained in the configuration template/data. Using the provided fields and the toggle buttons depicted in FIG. 3B, the user can personalize the configuration template or re-adjust the values of the configuration data. As shown in FIG. 3B, the GUI can be provided with a button (e.g., question mark) which provides the user with a detailed explanation of each setting presented in the GUI. As explained above, some fields can be pre-populated with the values from the user's previously adjusted configuration data. The GUI can be designed in various other ways depending on the types of parameters and/or the types of features being adjusted. Upon completion of personalizing the configuration template/data, the configuration application 112 stores the configuration data in any of the designated storage locations described above.

Some embodiments of the present disclosure include a step of activating the vehicle's configuration mode. (step 210) Placing the vehicle in the configuration mode can be done manually or automatically. For example, the user may activate the configuration mode by sending an activation command to the control module 130 via the user client 110. As mentioned earlier, the user client 110 and the control module 130 can be paired, synced, or otherwise connected via any commonly known wire, wireless, or a combination of such communication networks. In some cases, the user client 110 may communicate with the control module 130 via radio signals, such as Bluetooth or Wireless Fidelity (“WI-FI”) protocols. In some other cases, a cellular network can be used for communication between the user client 110 and the control module 130. Furthermore, the activation signal need not be received via the user client 110. Instead, the user may interact directly with the vehicle to activate the configuration mode (e.g., pressing a button in the vehicle). In yet another example, the user client 110 or any other devices (e.g., a key having a RDIF chip, a device with a near-field-communication chip) may be configured to automatically send an activation signal to the control module 130 when a predetermined condition (e.g., physical distance between the user and the vehicle) is met.

The configuration data is transferred to the control module 130. (step 212) In an embodiment, the configuration data is transferred from the user client 110 via any one or a combination of the aforementioned wired or wireless connection mechanisms. In an alternate embodiment, the configuration data is transferred from a remote vehicle database (e.g., remote server) via the wireless network. When necessary, the control module 130 can be tethered to a network enabled device (e.g., user client) to establish data connection to the remote vehicle database 120. If a tethered network connection is not feasible, the control module 130 may obtain the configuration data via a portable storage device, such as USB flash drive or any other non-volatile memory devices. Upon receiving the configuration data, the control module 130 can send signals to various devices and modules of the vehicle to adjust the settings according to the configuration data.

The foregoing description, for purpose of explanation, has been described with reference to specific embodiments. However, the illustrative discussions above are not intended to be exhaustive or to limit the disclosure to the precise forms disclosed. Many modifications and variations are possible in view of the above teachings. The embodiments were chose and described in order to best explain the principles of the disclosure and its practical applications, to thereby enable other skilled in the art to best utilize the disclosure and various embodiments with various modifications as are suited to the particular use contemplated.

We claim:

1. A method for managing vehicle configurations, comprising:
receiving one or more vehicle identification data for a user's vehicle;
obtaining a configuration data, the configuration data corresponding to the vehicle identification data;
adjusting one or more parameters of the configuration data; and
transferring the adjusted configuration data to a control module of the vehicle, wherein the control module configures the vehicle in accordance with the configuration data.

2. The method of claim 1, wherein the one or more vehicle identification data comprises at least one of:
a unique vehicle identifier;
Year/Make/Model information;
a user account information; and
a unique user client identifier.

3. The method of claim 1, wherein the configuration data is obtained from a vehicle database.

4. The method of claim 3, wherein the configuration data from the vehicle database comprises a configuration template.

5. The method of claim 3, wherein the configuration data from the vehicle database comprises the user's previously stored configuration data.

6. The method of claim 1, wherein the vehicle identification data and the configuration data are acquired from the vehicle.

7. The method of claim 4, further comprising:
analyzing the user's patterns relating to vehicles; and
automatically populating the parameters of the configuration template based on the analysis.

8. The method of claim 7, wherein analyzing the user's patterns comprises analyzing the user's configuration patterns from the user's previously stored configuration data.

9. The method of claim 7, wherein analyzing the user's patterns comprises analyzing the user's driving pattern.

10. The method of claim 7, wherein analyzing the user's pattern comprises analyzing the user's vehicle feature usage pattern.

11. The method of claim 1, wherein the adjusted configuration data is transferred from a user client to the control module.

12. The method of claim 1, wherein the adjusted configuration data is transferred from a remote server to the control module.

13. The method of claim 1, wherein the adjusted configuration data is transferred to the control module via a removable storage medium.

14. A system for managing vehicle configurations, comprising:
at least one vehicle database comprising information for identifying vehicles and at least one configuration data;
at least one user client for accessing a memory storing a configuration application configured to obtain a vehicle identification data, acquire at least one configuration data, permit the user to adjust the configuration data, and transfer the adjusted configuration data; and
a control module operatively coupled to the vehicle for configuring the vehicle in accordance with the configuration data.

15. The system of claim 14, wherein the vehicle database is implemented in the user client.

16. The system of claim 14, wherein the vehicle database is implemented in a remote server.

17. The system of claim 14, wherein the configuration application is implemented in the user client.

18. The system of claim 14, wherein the configuration application is implemented in a remote server.

19. A non-transitory computer readable storage medium storing one or more programs to be executed on one or more computational devices, the one or more programs having instructions for:
receiving one or more vehicle identification data;
acquiring a configuration data corresponding to the vehicle identification data;
presenting the parameters of the configuration data to a user;
adjusting the parameters of the configuration data; and
transferring the adjusted configuration data to a control module operatively coupled to a vehicle for configuring the vehicle in accordance with the transferred configuration data.

20. The non-transitory computer readable storage medium of claim 19, further comprising:
instructions for analyzing the user's patterns relating to vehicles; and
automatically populating the parameters of the configuration data before presenting the parameters to the user for adjustment.
